(19) United States
(12) Patent Application Publication
(10) Pub. No.: US 2009/0144054 A1
(43) Pub. Date: Jun. 4, 2009

(54) Embedded system to perform frame switching

(75) Inventor: B. Sudhakar, Bangalore (IN)

Correspondence Address: SPRINKLE IP LAW GROUP, 1301 W. 25TH STREET, SUITE 408, AUSTIN, TX, 78705, US

(73) Assignee: Kabushiki Kaisha Toshiba, Tokyo (JP)

(21) Appl. No.: 12/313,794

(22) Filed: Nov. 25, 2008

(30) Foreign Application Priority Data
Nov. 30, 2007 (IN) 2816/CHE/2007

(51) Int. Cl. G10L 19/14

(52) U.S. Cl. 704/211; 704/E19.039

(57) ABSTRACT

The present patent discloses an embedded transient detection module, which improves the quality of the audio encoder, at the same time requires less computational power, as compared to existing schemes. This module uses a long frame, when the input audio signal is in steady state, while a short frame is used, when there are transients in the signal.

### RELATED APPLICATIONS

This application claims the benefit of priority of Indian Patent Application Serial No. 2816/CHE/2007 by inventor B. Sudhakar, entitled “Embedded System to Perform Frame Switching” filed on Nov. 30, 2007, the entire contents of which are hereby expressly incorporated by reference for all purposes.

### TECHNICAL FIELD

The present invention relates to the field of audio signal processing. More particularly, the invention relates to analysis of a signal in time domain, which detects the area of the signal, where there is a sudden change in signal (attack).

### BACKGROUND AND PRIOR ART

Audio processing refers to the processing of the representation of sound in the form of analog or digital signals. Analog signals are continuous electrical signals, with a voltage level or a current level representing the sound. In digital signals, the sound wave is represented by binary symbols i.e. in the form of 1s or 0s. Sound signals are in the form of continuous signals, so they must be converted to digital signals by quantizing and sampling the signals. Digital signals offer advantages such as ease of processing, editing as compared to analog signals.

In perceptual audio encoding methods, inappropriate temporal spread of quantization noise leads to “pre-noise” artifacts. These artifacts occur when a transient signal is being coded in a spectral representation because the quantization noise is spread out over the entire window length of the filter bank and is not masked by the signal.

To avoid this problem, in the perceptual entropy based method, frame type processing is done. The frame type is determined by the psychoacoustic model. Perceptual entropy is calculated in the psychoacoustic model and if the perceptual entropy model is above some threshold (the value of the threshold depends on the coded being employed), then a short frame is used, as the comparatively high perceptual entropy indicates a transient signal. If the perceptual entropy is below some threshold, then a long frame is used, as the comparatively low perceptual entropy indicates a steady state signal. The perceptual entropy method relies a lot on very accurate block switching, the absence of which will result in wastage of bits and hence poor quality.

U.S. Pat. No. 6,453,282 claims a “Method and device for detecting a transient in a discrete-time audio signal”. The above mentioned patent discloses a method which consists of the following steps, as shown in FIG. 1:
a) segmenting the audio signal into segments of equal length (101);
b) using a high pass filter, lower frequency components of the audio signal are attenuated (102);
c) a rise detector compares the energy of the filtered signal of preset segment with the energy levels of the previous segment (103);
d) comparing the filters and unfiltered energies of the present and previous segments, using a spectral detector (104);
e) detecting a transient based on the comparisons performed in steps (c) and (d).

As can be seen from the above steps, comparison is performed twice, leading to lowered efficiency of the system.

The methods mentioned above have disadvantages like lower quality and high computation requirement (the perceptual entropy method) or from lower efficiency (U.S. Pat. No. 6,453,282), as compared to the present invention.

### OBJECTS OF THE INVENTION

An object of the invention is to have an efficient transient detection system in the time domain for improving the quality of an audio encoder.

Another object of this invention is to have a transient detection system, which works in the time domain for reducing the memory needed for encoding an audio signal.

### STATEMENT OF THE INVENTION

According to one aspect of the invention, in an embedded transient detection module, a high pass filter is used to remove the low frequency components from the input time domain signal, the filtered signal is segmented into sub-frames and the signal analysis happens within these sub-frames, the system is used to analyze the rate of change of energies over a period of about one and half sub-frames and based on this a decision is made as to which frame type has to be used, long frame (default) or short frame (for transient signal) further processing is done based on this frame decision.

According to another embodiment of the invention, in an embedded transient detection module, the input time domain audio signals is segmented into sub-frames and a high pass filter is applied to each of the sub-frames, by which the low frequencies are removed. The filtered signal is segmented into sub-frames and the signal analysis happens within these sub-frames, the system is used to analyze the rate of change of energies over a period of about one and half sub-frames and based on this a decision is made as to which frame type has to be used, long frame (default) or short frame (for transient signal) further processing is done based on this frame decision.

Further objects, features and advantages will become apparent from the following description, claims and drawings.

### BRIEF DESCRIPTION OF THE DRAWINGS

The above aspects of the invention are described in detail with reference to the attached drawings, where:

FIG. 1 shows the existing prior art for this invention;

FIG. 2 shows the block diagram for a first embodiment of the transient detection module;

FIG. 3 shows an example of the audio encoding system, where a time domain audio signal is provided as input to the transient detection module;

FIG. 4 shows the workflow for the transient detection module, in case of the first embodiment;

FIG. 5 shows the block diagram for a second embodiment of the transient detection module;

FIG. 6 shows the workflow of the transient detection module, in case of the second embodiment; and

FIG. 7 shows an implementation of the transient detection module in a real world scenario.

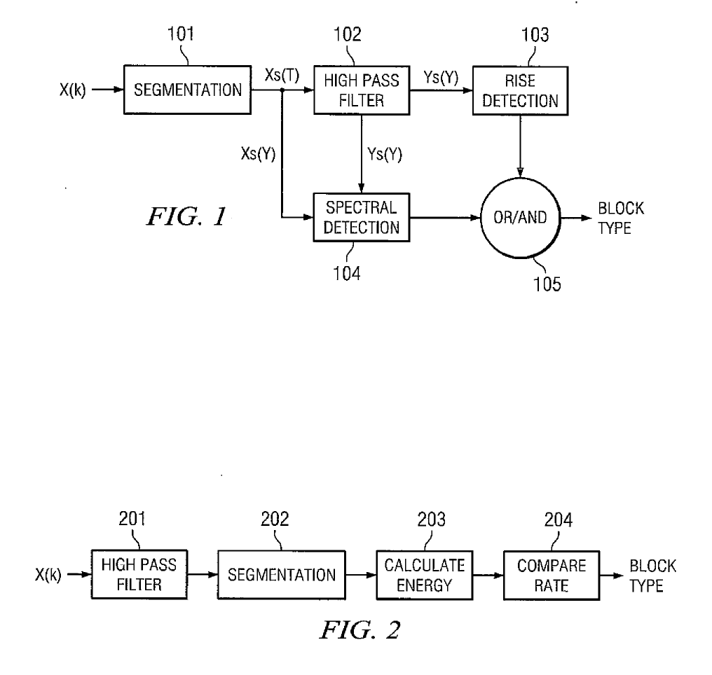

### DETAILED DESCRIPTION OF THE INVENTION

In perceptual audio coding, inappropriate spread of quantization noise leads to “pre-echo” artifacts. A solution to the pre-echo problem is the process of frame switching, which defines two different frame sizes. Long frame size is used in steady state signal conditions, which provides very good frequency resolution and thus provides high coding gain. During attacks i.e. signals with heavy transients, short frames with very good temporal resolution are used. The transient detection module decides which frame type is to be applied for each sub-frame.

The transient detection module system is shown in FIG. 2. The transient detection module performs signal analysis in the time domain. In this module, a high pass filter (201) is applied to the input time domain audio signal X(k), removing the low frequency components. Each frame of the filtered signal is segmented into sub-frames (202) and signal analysis is performed over each of the sub-frames. The rate of change of energies over a period of one and a half sub-frames is analyzed (203). Based on the rate of change of energies, a decision is made as to which frame type is to be used (204). Further processing is done by the system based on this frame decision.

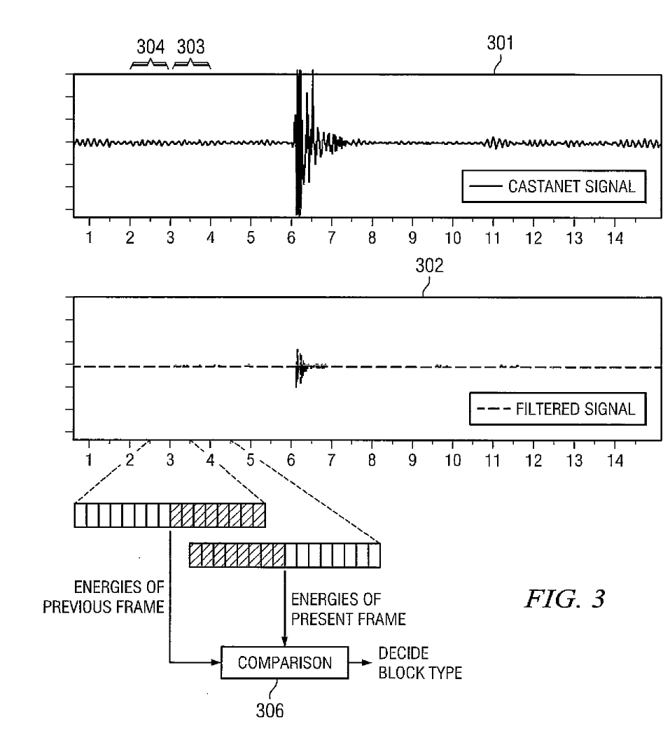

FIG. 3 is a visual representation of the function performed by the transient detection algorithm. (301) is the time domain audio signal, which is the input to the embedded system. The time domain signal is then passed through the high pass filter, to remove the low frequency components. (302) shows the signal once it has been passed through the high pass filter. One frame of data (frame 4, in this example) (303) is analyzed. One frame is segmented into sub-frames of N equal sizes and energy in each sub-frame is calculated using the formula given below.

$$Energy = {\sum }_{i = 0}^{FRAMESIZE / N} {Sample}^{2}$$

The system compares the energy from the current sub-frame with the energy from the previous sub-frame, which is stored in the system memory. The system analyses the rate of change of energy (305). If the rate of change of energy is high, short frame is used; else if the rate of change of energy is low, long frame is used.

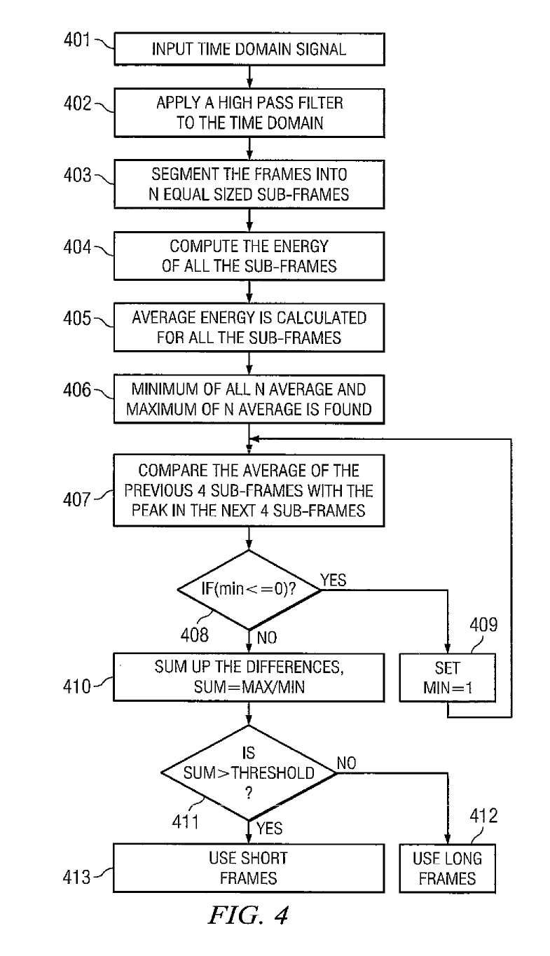

FIG. 4 shows the workflow for the method implemented by the embedded transient detection module to perform frame switching. A time domain audio signal is given as input to the transient detection module (401). A high pass filter is applied to the time domain signal to remove the low frequency components (402). The high pass filter is of a lower order in order to provide better efficiency and speed. Higher the order of the high pass filter, greater accuracy is provided, but computation is increased. This system can also work efficiently with lower order filters, which reduces the number of CPU memory cycles needed i.e. MCPS. At the same time, memory locations needed during the process is also reduced. Each frame of the segmented audio signal is divided into N sub-frames with S samples, where N is most preferably 16, but can be any number between 12 and 20 (403). The energy of each sub-frame is calculated, so that we have energy levels for the sub-frames as E₁, E₂, E₃, . . . , E_{N} (404). In the next step, the average energy is calculated for all the N sub-frames (405). During this process, some amount of energy (N/4) is used for energy comparison, to ensure smooth comparison. The system finds out the minimum of all N/4 average and maximum of all N/4 average is found and local maximum and minimum are calculated (406). The average of the previous four sub-frames are subtracted from the peak in the next four sub-frames (407). If the local minimum is less than or equal to zero (408), then the local minimum is made equal to 1 (409) and the system steps back to step (407). If the local minimum is greater than zero (408), then the ratio of local maximum and minimum and sum up the ratios for the first sub-frame, henceforth referred to as SUM (409). This step is repeated for all the N sub-frames. If the value of SUM is greater than a threshold value (411), short frames are used (413) (as the higher value of SUM indicates a transition in the signal). If the value of SUM is less than a threshold value, long frames are used (412) (as the lower value of SUM indicates a steady signal).

The threshold value is set by following the steps given below:
a) consider a test stream with many transients;
b) mark the frame numbers visually, where there are transients;
c) set a value such that the transients can be detected, wherever located;
d) ensure that short frame is not used, when the stream is in steady state;
e) ensure that there is no pre-echo present; if pre-echo is present, do more fine tuning;
f) ensure that an average listener cannot distinguish between the original stream and the encoded stream.

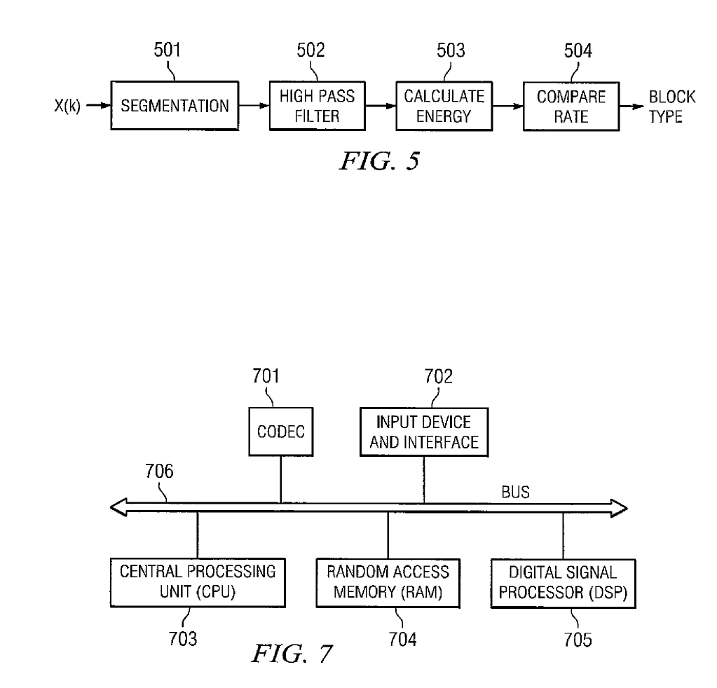

In another embodiment of the transient detection module, segmentation can be performed on the input time domain audio signal before the high pass filter, with the high pass filter removing the low frequency components from each of the sub-frames. Considering FIG. 5, where the high pass filter (502) has been placed after the segmentation block (501) in the transient detection module. Each frame of the input time domain audio signal is divided into sub-frames in the segmentation block (501). The high pass filter (502) removes the low frequency components from each of the sub-frames. The rate of change of energies over a period of one and a half sub-frames is analyzed (503). Based on the rate of change of energies, a decision is made as to which frame type is to be used (504). Further processing is done by the system based on this frame decision.

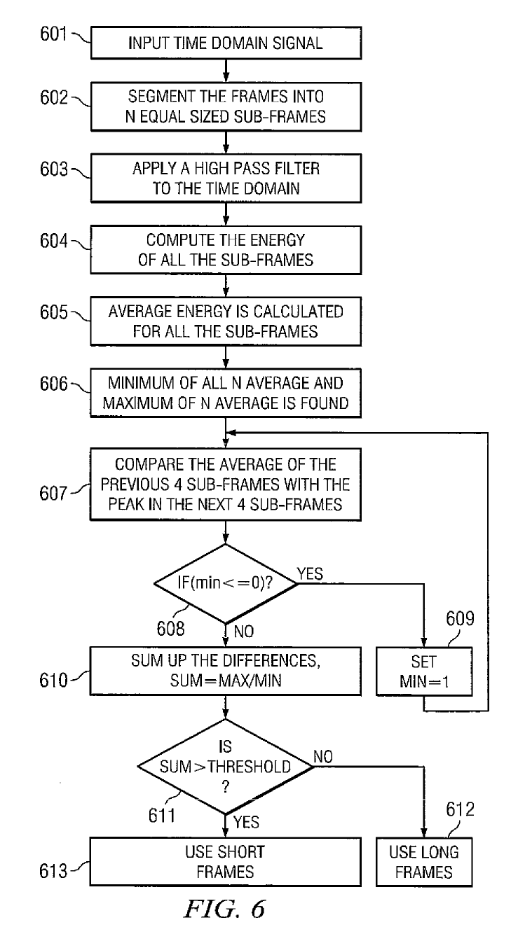

FIG. 6 illustrates the workflow for the above embodiment. A time domain audio signal is given as input to the transient detection module (601). Each frame of the segmented audio signal is divided into N sub-frames with S samples, where N is most preferably 16, but can be any number between 12 and 20 (602). A high pass filter is applied to each of the N sub-frames to remove the low frequency components (603). The high pass filter is of a lower order in order to provide better efficiency and speed. Higher the order of the high pass filter, greater accuracy is provided, but computation is increased. This system can also work efficiently with lower order filters, which reduces the number of memory cycles needed i.e. MCPS. The energy of each sub-frame is calculated, so that we have energy levels for the sub-frames as E₁, E₂, E₃, . . . , E_{N} (604). In the next step, the average energy is calculated for all the N frames (605). During this process, some amount of energy (N/4) is used for energy comparison, to ensure smooth comparison. The system finds out the minimum of all N/4 average and maximum of all N/4 average is found and local maximum and minimum are calculated (606). The average of the previous four sub-frames are subtracted from the peak in the next four sub-frames (607). If the local minimum is less than or equal to zero (608), then the local minimum is made equal to 1 (609) and the system steps back to step (607). If the local minimum is greater than zero (608), then the ratio of local maximum and minimum and sum up the ratios for the first sub-frame, henceforth referred to as SUM (609). This step is repeated for all the N sub-frames. If the value of SUM is greater than a threshold value (611), short frames are used (613) (as the higher value of SUM indicates a transition in the signal). If the value of SUM is less than a threshold value, long frames are used (612) (as the lower value of SUM indicates a steady signal).

A basic block diagram of System-on-a-Chip (SoC) is as shown in FIG. 7. The SoC has blocks like codecs (701), input device and user interface (702), the central processing unit (CPU) (703), the random access memory (704), digital signal processing unit (DSP) (705) and a bus to enable communication between these modules (706). The input device and user interface (702) is connected to input and output devices like keypads, touch screens, LCDs and so on. Codecs (701) are used to convert the analog sound signal into the digital domain. The CPU (703) provides commands to the other modules to perform operations on the signal and the RAM (704) provides the memory necessary for conducting the audio processing. The transient detection module resides in the DSP (705) and processes the time domain input signal. This SoC finds applications in portable audio players, television systems, music systems.

Although the present invention has been described with particular reference to specific examples, variations and modifications of the present invention can be effected within the spirit and scope of the following claims.

What is claimed is:

1. A method to determine the frame type in each frame of input time domain audio signal in an audio encoding system by performing the given steps:
a) a high pass filter is applied to the input audio signal;
b) each frame of the filtered signal is divided into N sub-frames, with S samples each;
c) the energy coefficients for each sub-frame of the filtered signal is calculated;
d) the rate of change of energies over one and half sub-frames is analyzed;
e) a long frame is used if there is no change in the energy levels;
f) a short frame is used if there is a change in the energy levels.

2. A method, according to claim 1, where N can have any value between 12 and 20.

3. A method, according to claim 1, where N has a value of 16.

4. A method, according to claim 1, where the energy coefficients are calculated as follows:
a) the energy of all the N sub-frames is calculated;
b) the average energy for all the N sub-frames is calculated;
c) the minimum of all N average and maximum of all N average is found;
d) the local maximum and local minimum is calculated;
e) the average of the previous four sub-frames is compared with the peak in the next four sub-frames;
f) the local minimum is made equal to 1, if the local minimum is less than or equal to zero;
g) SUM is calculated for all N sub-frames, the sum of the ratios of the local maximum and local minimum;
h) SUM is compared with a threshold value.

5. A method, according to claim 4, where if SUM is greater than a threshold value, long frame is used.

6. A method, according to claim 4, where if SUM is less than a threshold value, short frame is used.

7. A method, according to claim 4, where a long frame is used in steady state signal conditions.

8. A method, according to claim 4, where a short frame is used for transient signals.

9. A system to determine the frame type in each frame of input time domain audio signal in an audio encoding system, comprising of:
a) a high pass filter, to filter out the low frequency components;
b) a segmentation block, to segment each frame into sub-frames;
c) a block to calculate the energy of each sub-frame;
d) an energy comparator block to compare the rate of energy change in each sub-frame.

10. A method to determine the frame type in each frame of input time domain audio signal in an audio encoding system by performing the given steps:
a) each frame of the input time domain signal is divided into N sub-frames, with S samples each;
b) a high pass filter is applied to each of the sub-frames for all the samples;
c) the energy coefficients is calculated for each sub-frame of the filtered signal;
d) the rate of change of energies is analyzed over one and half sub-frames;
e) a long frame is used if there is no change in the energy levels;
f) a short frame is used if there is a change in the energy levels.

11. A method, according to claim 10, where N can have any value between 12 and 20.

12. A method, according to claim 10, where N has a value of 16.

13. A method, according to claim 10, where the energy coefficients are calculated as follows:
a) the energy of all the N sub-frames is calculated;
b) the average energy for all the N sub-frames is calculated;
c) the minimum of all N average and maximum of all N average is found;
d) the local maximum and local minimum is calculated;
e) the average of the previous four sub-frames is compared with the peak in the next four sub-frames;
f) the local minimum is made equal to 1, if the local minimum is less than or equal to zero;
g) SUM is calculated for all N sub-frames, the sum of the ratios of the local maximum and local minimum;
h) SUM is compared with a threshold value.

14. A method, according to claim 13, where if SUM is greater than a threshold value, long frame is used.

15. A method, according to claim 13, where if SUM is less than a threshold value, short frame is used.

16. A method, according to claim 13, where a long frame is used in steady state signal conditions.

17. A method, according to claim 13, where a short frame is used for transient signals.

18. A system to determine the frame type in each frame of input time domain audio signal in an audio encoding system, comprising of:
a) a segmentation block, to segment each frame into sub-frames;
b) a high pass filter, to filter out the low frequency components from each sub-frame;
c) a block to calculate the energy of each sub-frame;
d) a energy comparator block to compare the rate of energy change in each sub-frame.
